(19) United States
(12) Patent Application Publication
(10) Pub. No.: US 2026/0315970 A1
(43) Pub. Date: Oct. 15, 2026

(54) NANOFIBER COMPOSITE AIR PURIFICATION FILTER MATERIAL AND ITS PREPARATION METHOD

(71) Applicant: JIAXING FREBANG NEW MATERIAL TECHNOLOGY CO., LTD., Jiaxing City (CN)

(72) Inventors: XINGLEI ZHAO, Shanghai City (CN); PAN JIANG, Huanggang City (CN); TING HUA, Shanghai City (CN); PENG WANG, Shanghai City (CN)

(73) Assignee: JIAXING FREBANG NEW MATERIAL TECHNOLOGY CO., LTD., Jiaxing City (CN)

(21) Appl. No.: 19/682,354

(22) Filed: May 19, 2026

Related U.S. Application Data
(63) Continuation of application No. PCT/CN2025/081734, filed on Mar. 11, 2025.

(30) Foreign Application Priority Data
Mar. 12, 2024 (CN) 202410280675.X

(51) Int. Cl. B01D 39/16; B01D 46/54; D01D 1/02; D01D 5/098; D01F 1/10; D01F 8/06; D04H 1/4291; D04H 1/435; D04H 1/4374; D04H 1/4382; D04H 1/46; D04H 1/541; D04H 1/555; D04H 1/559; D04H 1/56; D04H 3/16

(52) U.S. Cl. CPC B01D 39/163; B01D 46/543; B01D 46/546; D01D 1/02; D01D 5/0985; D01F 1/10; D01F 8/06; D04H 1/4291; D04H 1/435; D04H 1/4374; D04H 1/43825; D04H 1/46; D04H 1/541; D04H 1/555; D04H 1/559; D04H 1/56; D04H 3/16; B01D 2239/025; B01D 2239/0407; B01D 2239/0618; B01D 2239/0622; B01D 2239/0627; B01D 2239/0672; B01D 2239/10; D10B 2321/021; D10B 2321/022; D10B 2505/04

(57) ABSTRACT

Provided are a nanofiber composite air purification filter material and its preparation method. The nanofiber composite air purification filter material includes a four-layer composite structure from top to bottom, namely non-woven fabric, nanofiber membrane layer, modified melt-blown non-woven fabric, and spunbond non-woven fabric. The non-woven fabric is PET needle-punched non-woven fabric. The raw materials for preparing the nanofiber membrane layer, based on weight fractions, include the following components: 10-20 parts of polylactic acid, 3-5 parts of a reinforcing agent, 2-4 parts of modified nanoparticles, and 100-150 parts of solvent. The material of the spunbond non-woven fabric is PET or PP. The nanofiber composite air purification filter material provided by the present disclosure has breathability, radiation resistance, and antibacterial properties, and can be widely used in the field of air purification filter materials, with good commercial application value.

### CROSS-REFERENCE

This application is a continuation of International Application No. PCT/CN2025/081734 with a filling date of Mar. 11, 2025, designating the United States, now pending, which further claims to the benefit of priority from Chinese Application No. 202410280675.X with a filing date of Mar. 12, 2024. The content of the aforementioned applications, including any intervening amendments thereto, are incorporated herein by reference.

### TECHNICAL FIELD

The present disclosure relates to the technical field of air purification, specifically to the technical field of air purification filter materials, and particularly to a nanofiber composite air purification filter material and its preparation method.

### BACKGROUND

In recent years, with the rapid development of industry in China, the problem of air quality has become increasingly severe, especially the environmental problems characterized by PM10 and PM2.5 pollutants, which have attracted more and more attention. These particulate pollutants not only reduce visibility, but also pose serious threats to human health. Meanwhile, indoor environments of human activities are often filled with particulate matter, formaldehyde, volatile organic compounds, bacteria, and pathogens, all of which can pose a threat to human health. In order to purify the air more effectively, air purification technology has received widespread attention, and the development of air purification filter materials that play a major role in purifying the air has become a research hotspot for researchers in recent years.

At present, air purification filter materials, such as masks, are mainly composed of multiple layers of non-woven fabric, but they have problems such as high resistance, low accuracy, and filter efficiency attenuation. Unlike non-woven fabric, nanofiber membrane materials have the advantages of small pore size, high porosity, and controllable structure. However, nanofiber membrane air filter materials have the disadvantages of fragile structure, poor stability, and high cost. Therefore, it is particularly important to combine non-woven fabrics with high strength and good dimensional stability with nanofiber membrane layers with high porosity to prepare new air purification filter materials. However, there are still some shortcomings in the existing technology that need to be addressed, such as the difficulty in compounding nanofiber membrane layers with non-woven fabrics, which leads to insufficient breathability of air purification filter materials; the main components of non-woven fabric materials are polymer materials such as PET and PP, which are prone to yellowing and aging under long-term exposure to ultraviolet radiation and other forms of radiation; non-woven fabrics and nanofiber membrane materials themselves do not have bactericidal properties, resulting in insufficient filtration of bacterial substances in the air, in addition, bacteria and other microorganisms may adsorb on the surface of air purification filter materials during long-term use, which can also lead to secondary infections.

Patent application CN115897293A discloses an antibacterial air filter material and its preparation method. The application loads antibacterial substances on the fibers themselves, which enhances the strength of the filter material while having high antibacterial performance. However, it does not involve the issue of radiation protection of air filter materials. Patent application CN111203116A discloses a washable wide-width air filtration composite membrane, its preparation method, and application. The application combines the support material and heavy ion microporous membrane material together through ultrasonic composite, making the air filtration material have good composite mechanical strength and breathability, but it does not solve the problem of low radiation resistance and antibacterial properties of the air filtration material.

Therefore, there is an urgent need for an air purification filter material with good breathability, radiation resistance, and antibacterial properties on the market.

### SUMMARY

In response to the problems existing in the existing technology, the present disclosure uses ultrasonic composite to prepare a nanofiber composite air purification filter material by bonding the four-layer structure of non-woven fabric, nanofiber membrane layer, modified melt-blown non-woven fabric, and spunbond non-woven fabric from top to bottom, making the air purification filter material have the advantages of breathability, radiation resistance, and antibacterial performance.

In order to achieve the above objective, the technical solution adopted by the present disclosure is as follows:

The present disclosure provides a nanofiber composite air purification filter material, which includes a four-layer composite structure, from top to bottom, namely a non-woven fabric, a nanofiber membrane layer, a modified melt-blown non-woven fabric, and a spunbond non-woven fabric.

The non-woven fabric is PET needle-punched non-woven fabric.

The raw materials for preparing the nanofiber membrane layer, based on weight fractions, include the following components: 10-20 parts of polylactic acid, 3-5 parts of a reinforcing agent, 2-4 parts of modified nanoparticles, and 100-150 parts of solvent.

The material of the spunbond non-woven fabric is PET or PP.

The applicant prepared air purification filter material by bonding multiple layers of non-woven fabric and nanofiber membrane layer through ultrasonic composite. In one aspect, the applicant selected PET needle-punched non-woven fabric as the upper structure, making the air purification filter material strong, durable, and cost-effective; in another aspect, non-woven fabrics prepared by melt-blown and spunbond processes are selected as the lower layer structure, combining the advantages of high strength and good dimensional stability of spunbond non-woven filament fiber webs, as well as the high loft with ultra-fine short fiber network and good breathability of melt-blown non-woven; in another aspect, the applicant prepared a nanofiber membrane layer mainly made of polylactic acid as the intermediate layer, due to good biocompatibility of the polylactic acid, it can be well combined with multi-layer non-woven fabric structures under the action of ultrasonic composite, enhancing the adsorption capacity of air purification filter materials for nanoscale harmful particles.

In some embodiments of the present disclosure, the polylactic acid in the nanofiber membrane layer is poly(L-lactic acid), and the reinforcing agent is a β-nucleating agent.

Preferably, the molecular weight of the poly(L-lactic acid) is between 90000 and 110000; the β-nucleating agent is a rare earth β-nucleating agent.

More preferably, the type of rare earth beta nucleating agent is WBG-II.

The present disclosure does not impose any special restrictions on the source of WBG-II and are commercially available, including but not limited to purchasing from Guangdong Weilina Functional Materials Co., Ltd.

Polylactic acid is a good biodegradable material with the advantages of environmental protection, breathability, light weight, good resilience, and good luster.

The applicant selects poly(L-lactic acid) with a wide source of raw materials, good mechanical properties, and good formability, and selects rare earth β-nucleating agent as nucleating agent for polylactic acid, which can overcome the problems of poor impact performance and low thermal deformation temperature of polylactic acid.

In some embodiments of the present disclosure, the method for preparing modified nanoparticles includes the following steps:
\textcircled{1} adding TiO₂ powder to sodium hydroxide solution, placing in a polytetrafluoroethylene reaction vessel for sealing after ultrasonic treatment, then drying, washing, drying, and grinding to obtain a precursor for later use;
\textcircled{2} taking the precursor obtained from step \textcircled{1}, adding barium nitrate and deionized water, placing in a polytetrafluoroethylene reaction vessel for sealing after ultrasonic treatment, then heating, washing, drying, and grinding to obtain nanoparticles for later use;
\textcircled{3} adding 1-(3-aminopropyl)imidazole, tea polyphenols, isopropanol, and deionized water in sequence to the nanoparticles obtained in step 2, then heating, stirring, drying, and grinding to obtain the modified nanoparticles.

Preferably, the preparation method of the modified nanoparticles includes the following steps:
\textcircled{1} adding TiO₂ powder to sodium hydroxide solution, placing in a polytetrafluoroethylene reaction vessel for sealing after 20-40 minutes of ultrasonic treatment, then drying at 200° C. for 12 hours, washing three times each with anhydrous ethanol and deionized water, drying at 60° C. for 4 hours, and grinding to obtain a precursor for later use;
\textcircled{2} taking the precursor obtained from step \textcircled{1}, adding barium nitrate and deionized water, placing in a polytetrafluoroethylene reaction vessel for sealing after 30 minutes of ultrasonic treatment, then heating at 200° C. for 10 hours, washing three times each with anhydrous ethanol and deionized water, drying at 60° C. for 4 hours, and grinding to obtain nanoparticles for later use;
\textcircled{3} adding 1-(3-aminopropyl)imidazole, tea polyphenols, isopropanol, and deionized water in sequence to the nanoparticles obtained in step 2, then heating at 40-50° C., stirring for 20-40 minutes, drying at 60° C. for 4 hours, and grinding to obtain the modified nanoparticles.

The particle size of TiO₂ powder is 20-40 nm.

The present disclosure does not impose any special restrictions on the source of the TiO₂ powder and are commercially available, including but not limited to purchasing from Shanghai Aladdin Biochemical Technology Co., Ltd.

In some embodiments of the present disclosure, in step 3, the mass ratio of the nanoparticles obtained in step 2, the 1-(3-aminopropyl)imidazole, and the tea polyphenols is 1:(0.3-0.5):(0.15-0.35).

Preferably, the mass ratio of the nanoparticles obtained in step 2, the 1-(3-aminopropyl)imidazole, and the tea polyphenols is 1:0.4:0.25.

Compared to ordinary non-woven fabrics, nanofiber membranes have smaller pore sizes and higher filtration efficiency, especially in increasing the filtration efficiency of nanoscale particles. Polylactic acid, as an environmentally friendly biodegradable material, has the advantages of light weight, good breathability, and good resilience. However, it has the disadvantages of insufficient strength and antibacterial properties. The applicant modified TiO₂ powder to prepare modified nanoparticles to optimize the performance of polylactic acid nanofiber membranes. On the one hand, the applicant prepared highly active BaTiO₃ nanoparticles from TiO₂ powder through a two-step hydrothermal method, BaTiO₃ nanoparticles can be embedded in situ on the surface of polylactic acid, overcoming the problem of poor dispersion of TiO₂ powder in polylactic acid, making polylactic acid nanofiber membranes have better antibacterial properties. Moreover, the embedding of BaTiO₃ nanoparticles on the surface of polylactic acid increases the overall crystallinity of the nanofiber membrane, thereby enhancing intermolecular interactions and improving the strength of the polylactic acid nanofiber membrane. On the other hand, the applicant introduced 1-(3-aminopropyl)imidazole and tea polyphenols into BaTiO₃ nanoparticles.

After introducing 1-(3-aminopropyl)imidazole into polylactic acid through BaTiO₃ nanoparticles, imidazole and amide groups appeared on the surface of polylactic acid. Imidazole groups can enhance the radiation resistance of nanofiber membranes, while amide groups can form hydrogen bonds with polylactic acid molecules, accelerating the nucleation rate of polylactic acid, saving the amount of nucleating agents and costs. Tea polyphenols, as a natural substance, can enhance the radiation resistance of nanofiber membranes.

In some embodiments of the present disclosure, the solvent is polyethylene glycol or dichloromethane.

Preferably, the solvent is polyethylene glycol with a molecular weight of 400-600.

In some embodiments of the present disclosure, the preparation method of the nanofiber membrane layer includes the following steps:

Mixing the polylactic acid, the reinforcing agent, and the modified nanoparticles in a solvent, standing at 40-50° C. for 4-6 hours, stirring to obtain a blend solution, and then electrospinning to obtain a nanofiber membrane layer.

In some embodiments of the present disclosure, the preparation method of the modified melt-blown non-woven fabric includes the following steps:
(1) adding concentrated hydrochloric acid and deionized water to a reaction vessel, adding samarium oxide powder in batches, heating to 45-55° C., stirring, performing vacuum filtration, adding ammonia water to adjust the pH to 7.5-8.5, performing vacuum filtration, washing, filtering, and drying to obtain a first reaction product for later use;
(2) taking the first reaction product obtained from step (1), adding methacrylic acid, heating to 75-85° C., stirring until the solution becomes clear, filtering, performing reduced-pressure distillation, cooling, performing vacuum filtration, drying to obtain a second reaction product for later use;
(3) mixing the second reaction product obtained from in step (2) with polyethylene masterbatch, and polypropylene masterbatch, drying in a vacuum environment, and then performing extrusion and melt spinning processes to obtain composite fibers for later use;
(4) placing ferrous sulfate, deionized water, and N-isopropylacrylamide in a reaction vessel, mixing, then adding the composite fibers from step (3), introducing inert gas for 8-15 minutes, heating at 65-75° C. for 2-4 hours, washing under ultraviolet light, drying to obtain mixture for later use;
(5) performing a melt-blown process on the mixture obtained in step (4) to obtain a modified melt-blown non-woven fabric.

Preferably, the preparation method of the modified melt-blown non-woven fabric includes the following steps:
(1) adding concentrated hydrochloric acid and deionized water to a reaction vessel, adding samarium oxide powder in batches, heating to 50° C., stirring for 20-40 minutes, performing vacuum filtration, adding 25 wt % ammonia water to adjust the pH to 8.0, performing vacuum filtration, washing three times with deionized water, filtering, and drying at 100° C. for 12 hours to obtain a first reaction product for later use;
(2) taking the first reaction product obtained from step (1), adding methacrylic acid, heating to 80° C., stirring until the solution becomes clear, filtering, performing reduced-pressure distillation, cooling, performing vacuum filtration, drying at 100° C. for 12 hours to obtain a second reaction product for later use;
(3) mixing the second reaction product obtained from in step (2) with polyethylene masterbatch, and polypropylene masterbatch, drying in a vacuum environment with the temperature of 100° C. for 12 hours, and then performing extrusion and melt spinning processes to obtain composite fibers for later use;
(4) placing ferrous sulfate, deionized water, and N-isopropylacrylamide in a reaction vessel, mixing, then adding the composite fibers from step (3), introducing inert gas for 10 minutes, heating at 70° C. for 3 hours, washing three times with deionized water under radiation of 220-260 nm ultraviolet light, drying at 60° C. for 4 hours to obtain mixture for later use;
(5) performing a melt-blown process on the mixture obtained in step (4) to obtain a modified melt-blown non-woven fabric.

The molecular weight of polyethylene masterbatch is 80000-100000, and the molecular weight of polypropylene masterbatch ranges from 100000 to 110000.

In some embodiments of the present disclosure, in step (3), the mass ratio of the second reaction product obtained from in step (2), the polyethylene masterbatch, and the polypropylene masterbatch is 1:(3-5):(7-9); in step (4), the mass ratio of the composite fibers obtained in step (3) and N-isopropylacrylamide is 1:(0.15-0.25).

Preferably, in step (3), the mass ratio of the second reaction product obtained from in step (2), the polyethylene masterbatch, and the polypropylene masterbatch is 1:4:8; in step (4), the mass ratio of the composite fibers obtained in step (3) and N-isopropylacrylamide is 1:0.2.

The present disclosure does not impose any special restrictions on the source of the polyethylene masterbatch, which are commercially available, including but not limited to purchasing from Dongguan YiLi Plastic Co., Ltd.; The present disclosure does not impose any special restrictions on the source of the polypropylene masterbatch, which are commercially available, including but not limited to purchasing from Shenzhen Jindaquan Technology Co., Ltd.

Melt-blown non-woven fabric is a type of non-woven material manufactured by melt-blown process using polymer materials. Two-component melt-blown non-woven fabric is favored by people because it can supplement the shortcomings of single polymer properties. In one aspect, the applicant prepared a two-component melt-blown non-woven fabric with polyethylene masterbatch and polypropylene masterbatch as the main components. Polypropylene has the advantages of flame retardancy and high temperature resistance, but its breathability is not good and it is not radiation-resistant. Compared with polypropylene, polyethylene has a more dispersed and loose molecular chain structure, which makes it breathable and comfortable to wear. Furthermore, polyethylene undergoes photocrosslinking reaction in the structure after absorbing radiation, thereby improving the radiation resistance of melt-blown non-woven fabric. Furthermore, polyethylene utilizes its hydrophobic properties to prevent water droplets from staying on the surface of non-woven fabric, thereby achieving anti-fog effects. In another aspect, the applicant added samarium oxide powder with radiation resistance to the melt-blown non-woven fabric, and prepared samarium methacrylate by modifying the samarium oxide powder. The unsaturated reactive groups in samarium methacrylate make it easier to undergo in-situ compatibilization reaction with polypropylene, resulting in a tighter bond between the samarium oxide powder and the melt-blown non-woven fabric, which is beneficial for improving the radiation resistance of air purification filter materials. In another aspect, the applicant introduced temperature sensitive N-isopropylacrylamide into composite fibers. As the reaction temperature increases, N-isopropylacrylamide can change from hydrophilic to hydrophobic, effectively filtering small molecule oil droplets on the surface of non-woven fabrics. The amide bond reacts with the acrylic bond of samarium methacrylate, promoting the grafting of N-isopropylacrylamide in composite fibers. In addition, the ferrous ions in ferrous sulfate can also play a certain antioxidant role in the synthesis process of melt-blown non-woven fabrics, thereby enhancing the radiation resistance of air purification filter materials.

In another aspect, the present disclosure further provides a method for preparing the nanofiber composite air purification filter material mentioned above, which includes the following steps:
S1, stacking the non-woven fabric, the nanofiber membrane layer, the modified melt-blown non-woven fabric, and the spunbond non-woven fabric from top to bottom in sequence;
S2, bonding the four layers of materials stacked together in step S1 through ultrasonic composite, thereby forming the nanofiber composite air purification filter material.

In some embodiments of the present disclosure, the ultrasonic composite has a power of 400-600 kW, with an ultrasonic frequency of 90-110 Hz.

Compared with the existing technology, the present disclosure has the following advantageous effects:
(1) The present disclosure combines a four-layer structure of non-woven fabric, nanofiber membrane layer, modified melt-blown non-woven fabric, and spunbond non-woven fabric through ultrasonic composite from top to bottom to prepare a nanofiber composite air purification filter material with breathable, radiation resistance, and antibacterial characteristics.
(2) The present disclosure uses polylactic acid as the main component, and the reinforcing agent, the modified nanoparticles, and the solvent are added to prepare a nanofiber membrane layer, which has high strength, antibacterial, and radiation resistance properties.
(3) The present disclosure uses polypropylene and polyethylene masterbatches as the main polymer components of a two-component melt-blown non-woven fabric, and the samarium oxide powder with radiation resistance and N-isopropylacrylamide with temperature sensitivity are added to prepare a synthetic modified melt-blown non-woven fabric, which has good breathability, radiation resistance, and anti-fog properties.
(4) The air purification filter material prepared by the present disclosure has good breathability, radiation resistance, and antibacterial properties, and can be widely used in the field of air purification filter materials, with good commercial application value.

### DETAILED DESCRIPTION OF THE EMBODIMENTS

The present disclosure will be explained in conjunction with specific implementation solution. It should be noted that the following embodiments are examples of the present disclosure, only used to illustrate the present disclosure, and not to limit the present disclosure. Other combinations and various improvements within the inventive concept may be made without departing from the spirit or scope of the present disclosure.

In the following embodiments, except for modified nanoparticles and modified melt-blown non-woven fabric, all other compound monomers and related reagents used can be purchased from the market. Among them, PET needle-punched non-woven fabric and PET spunbond non-woven fabric were purchased from Jiangxi Haorui Industrial Materials Co., Ltd.; Polylactic acid is poly(L-lactic acid) with an average molecular weight of 100000; The reinforcing agent is a rare earth β-nucleating agent, model WBG-II, purchased from Guangdong Weilina Functional Materials Co., Ltd.; The average particle size of TiO₂ powder is 30 nm, purchased from Shanghai Aladdin Biochemical Technology Co., Ltd.; The average molecular weight of polyethylene masterbatch is 90000, purchased from Dongguan Yili Plastic Co., Ltd.; The average molecular weight of polypropylene masterbatch is 105000, purchased from Shenzhen Jindaquan Technology Co., Ltd.; Polyethylene glycol was purchased from Tianjin Daixu Chemical Trade Co., Ltd. with molecular weights of 400, 500, and 600.

### Preparation Example 1

The preparation method of the modified nanoparticles includes the following steps:
\textcircled{1} Adding 30 g of TiO₂ powder to 100 ml of 8 mol/L sodium hydroxide solution, after ultrasonic treatment for 30 minutes, placing them in a polytetrafluoroethylene reaction vessel for sealing, then drying at 200° C. for 12 hours, then washing three times each with anhydrous ethanol and deionized water, drying at 60° C. for 4 hours, and grinding to obtain the precursor for later use;
\textcircled{2} Taking 10 g of the precursor obtained from step \textcircled{1}, adding 22 g of barium nitrate and 50 ml of deionized water, after ultrasonic treatment for 30 minutes, placing them in a polytetrafluoroethylene reaction vessel for sealing, then heating with a temperature of 200° C. for 10 hours, washing three times each with anhydrous ethanol and deionized water, drying at 60° C. for 4 hours, and grinding to obtain nanoparticles for later use;
\textcircled{3} Adding 8 g of 1-(3-aminopropyl)imidazole, 5 g of tea polyphenols, 15 ml of isopropanol, and 40 ml of deionized water in sequence to 20 g of the nanoparticles obtained in step 2, then heating with a temperature of 45° C., stirring for 30 minutes, drying at 60° C. for 4 hours, and grinding to obtain the modified nanoparticles A.

### Preparation Example 2

Modified nanoparticle B is synthesized using the same method as modified nanoparticle A. The raw materials used and the content of each raw material are basically the same as modified nanoparticle A. The difference is that in step \textcircled{3}, the mass of 1-(3-aminopropyl)imidazole and tea polyphenols are replaced with 5 g and 2.4 g, respectively.

### Preparation Example 3

The preparation method of the modified melt-blown non-woven fabric A includes the following steps:
(1) Adding 50 ml of 38 wt % concentrated hydrochloric acid and 100 ml of deionized water to a reaction vessel, then adding 30 g of samarium oxide powder in batches, then heating the mixture to 50° C., stirring for 30 minutes, performing vacuum filtration, then adding 25 wt % ammonia water to adjust the pH to 8.0, then performing vacuum filtration, washing three times with deionized water, filtering, and drying at 100° C. for 12 hours to obtain a first reaction product for later use;
(2) Taking 20 g of the first reaction product obtained from step (1), adding 40 g of methacrylic acid, heating the mixture solution to 80° C., stirring until the solution becomes clear, filtering, performing reduced-pressure distillation, cooling to room temperature, then performing vacuum filtration, drying at 100° C. for 12 hours to obtain a second reaction product for later use;
(3) Mixing 10 g of the second reaction product obtained from in step (2) with 40 g of polyethylene masterbatch and 80 g of polypropylene masterbatch, drying at 100° C. for 12 hours in a vacuum environment, and then performing extrusion and melt spinning processes to obtain composite fibers for later use;
(4) Placing 10 g of ferrous sulfate, 100 ml of deionized water, and 8 g of N-isopropylacrylamide in a reaction vessel, then adding 40 g of the composite fibers from step (3) after mixing, then introducing inert gas for 10 minutes, then heating at 70° C. for 3 hours, washing three times with deionized water under irradiation with 240 nm ultraviolet light, and then drying at 60° C. for 4 hours to obtain mixture for later use;
(5) Performing a melt-blown process on the mixture obtained in step (4) to obtain a modified melt-blown non-woven fabric A.

### Preparation Example 4

Modified melt-blown non-woven fabric B is synthesized using the same method as modified melt-blown non-woven fabric A. The raw materials used and the content of each raw material are basically the same as modified melt-blown non-woven fabric A. The difference is that in step (3), the mass of polyethylene masterbatch and polypropylene masterbatch are replaced with 25 g and 65 g, respectively.

### Preparation Example 5

Modified melt-blown non-woven fabric C is synthesized using the same method as modified melt-blown non-woven fabric A. The raw materials used and the content of each raw material are basically the same as modified melt-blown non-woven fabric A. The difference is that in step (4), the mass of N-isopropylacrylamide is replaced with 4.5 g.

### Embodiment 1

A nanofiber composite air purification filter material includes a four-layer composite structure, from top to bottom, namely a non-woven fabric, a nanofiber membrane layer, a modified melt-blown non-woven fabric A, and a spunbond non-woven fabric.

Among them, the thicknesses of the non-woven fabric, the nanofiber membrane layer, the modified melt-blown non-woven fabric A, and the spunbond non-woven fabric are 50 μm, 0.3 μm, 40 μm, and 20 μm, respectively.

The non-woven fabric is PET needle-punched non-woven fabric.

The raw materials for preparing the nanofiber membrane layer, based on weight fractions, include the following components: 15 parts of polylactic acid, 4 parts of reinforcing agent, 3 parts of modified nanoparticles A, and 125 parts of solvent.

The material of the spunbond non-woven fabric is PET.

The solvent is polyethylene glycol with a molecular weight of 500.

The preparation method of the nanofiber membrane layer includes the following steps:

Mixing the polylactic acid, the reinforcing agent, and the modified nanoparticles in the solvent, standing at 45° C. for 5 hours, stirring to obtain a blend solution, and then electrospinning to obtain a nanofiber membrane layer.

In the present embodiment, a method for preparing the nanofiber composite air purification filter material includes the following steps:
S1, stacking the four layers of materials, the non-woven fabric, the nanofiber membrane layer, the modified melt-blown non-woven fabric A, and the spunbond non-woven fabric from top to bottom in sequence;
S2, bonding the four layers of materials stacked together in step S1 through ultrasonic composite, thereby forming the nanofiber composite air purification filter material.

The ultrasonic composite has a power of 500 kW, with an ultrasonic frequency of 100 Hz.

### Embodiment 2

A nanofiber composite air purification filter material includes a four-layer composite structure, from top to bottom, namely a non-woven fabric, a nanofiber membrane layer, a modified melt-blown non-woven fabric A, and a spunbond non-woven fabric.

Among them, the thickness of the non-woven fabric, the nanofiber membrane layer, the modified melt-blown non-woven fabric A, and the spunbond non-woven fabric is the same as in embodiment 1.

The non-woven fabric is PET needle-punched non-woven fabric.

The raw materials for preparing the nanofiber membrane layer, based on weight fractions, include the following components: 10 parts of polylactic acid, 3 parts of reinforcing agent, 3 parts of modified nanoparticles A, and 100 parts of solvent.

The material of the spunbond non-woven fabric is PET.

The solvent is polyethylene glycol with a molecular weight of 400.

The preparation method of the nanofiber membrane layer includes the following steps:

Mixing the polylactic acid, the reinforcing agent, and the modified nanoparticles in the solvent, standing at 40° C. for 4 hours, stirring to obtain a blend solution, and then electrospinning to obtain a nanofiber membrane layer.

In the present embodiment, a method for preparing the nanofiber composite air purification filter material includes the following steps:
S1, stacking the four layers of materials, the non-woven fabric, the nanofiber membrane layer, the modified melt-blown non-woven fabric A, and the spunbond non-woven fabric from top to bottom in sequence;
S2, bonding the four layers of materials stacked together in step S1 through ultrasonic composite, thereby forming the nanofiber composite air purification filter material.

The ultrasonic composite has a power of 400 kW, with an ultrasonic frequency of 90 Hz.

### Embodiment 3

A nanofiber composite air purification filter material includes a four-layer composite structure, from top to bottom, namely a non-woven fabric, a nanofiber membrane layer, a modified melt-blown non-woven fabric A, and a spunbond non-woven fabric.

Among them, the thickness of the non-woven fabric, the nanofiber membrane layer, the modified melt-blown non-woven fabric A, and the spunbond non-woven fabric is the same as in embodiment 1;

The non-woven fabric is PET needle-punched non-woven fabric.

The raw materials for preparing the nanofiber membrane layer, based on weight fractions, include the following components: 20 parts of polylactic acid, 5 parts of reinforcing agent, 3 parts of modified nanoparticles A, and 150 parts of solvent.

The material of the spunbond non-woven fabric is PET.

The solvent is polyethylene glycol with a molecular weight of 600.

The preparation method of the nanofiber membrane layer includes the following steps:

Mixing the polylactic acid, the reinforcing agent, and the modified nanoparticles in the solvent, standing at 50° C. for 6 hours, stirring to obtain a blend solution, and then electrospinning to obtain a nanofiber membrane layer.

In the present embodiment, a method for preparing the nanofiber composite air purification filter material includes the following steps:
S1, stacking the four layers of materials, the non-woven fabric, the nanofiber membrane layer, the modified melt-blown non-woven fabric A, and the spunbond non-woven fabric from top to bottom in sequence;
S2, bonding the four layers of materials stacked together in step S1 through ultrasonic composite, thereby forming the nanofiber composite air purification filter material.

The ultrasonic composite has a power of 600 kW, with an ultrasonic frequency of 110 Hz.

### Embodiment 4

A nanofiber composite air purification filter material includes a four-layer composite structure, from top to bottom, namely a non-woven fabric, a nanofiber membrane layer, a modified melt-blown non-woven fabric A, and a spunbond non-woven fabric.

Among them, the thickness of the non-woven fabric, the nanofiber membrane layer, the modified melt-blown non-woven fabric A, and the spunbond non-woven fabric is the same as in embodiment 1;

The non-woven fabric is PET needle-punched non-woven fabric.

The raw materials for preparing the nanofiber membrane layer, based on weight fractions, include the following components: 12 parts of polylactic acid, 3.5 parts of reinforcing agent, 2 parts of modified nanoparticles A, and 120 parts of solvent.

The material of the spunbond non-woven fabric is PET.

The solvent is polyethylene glycol with a molecular weight of 500.

The preparation method of the nanofiber membrane layer and nanofiber composite air purification filter material in this embodiment is the same as that in embodiment 1.

### Embodiment 5

A nanofiber composite air purification filter material includes a four-layer composite structure, from top to bottom, namely a non-woven fabric, a nanofiber membrane layer, a modified melt-blown non-woven fabric A, and a spunbond non-woven fabric.

Among them, the thickness of the non-woven fabric, the nanofiber membrane layer, the modified melt-blown non-woven fabric A, and the spunbond non-woven fabric is the same as in embodiment 1;

The non-woven fabric is PET needle-punched non-woven fabric.

The raw materials for preparing the nanofiber membrane layer, based on weight fractions, include the following components: 18 parts of polylactic acid, 4.5 parts of reinforcing agent, 4 parts of modified nanoparticles A, and 140 parts of solvent.

The material of the spunbond non-woven fabric is PET.

The solvent is polyethylene glycol with a molecular weight of 500.

The preparation method of the nanofiber membrane layer and nanofiber composite air purification filter material in this embodiment is the same as that in embodiment 1.

### Embodiment 6

The present disclosure provides a nanofiber composite air purification filter material and its preparation method. The specific implementation method is the same as Embodiment 1, except that modified nanoparticles B is used in an equal amount to replace modified nanoparticles A.

### Embodiment 7

The present disclosure provides a nanofiber composite air purification filter material and its preparation method. The specific implementation method is the same as Embodiment 1, except that modified melt-blown non-woven fabric B is used in an equal amount to replace modified melt-blown non-woven fabric A.

### Embodiment 8

The present disclosure provides a nanofiber composite air purification filter material and its preparation method. The specific implementation method is the same as Embodiment 1, except that modified melt-blown non-woven fabric C is used in an equal amount to replace modified melt-blown non-woven fabric A.

### Comparative Example 1

This comparative example provides a nanofiber composite air purification filter material and its preparation method. The specific implementation method is the same as Embodiment 1, with the difference being that TiO₂ powder is used in place of the modified nanoparticle A.

### Comparative Example 2

This comparative example provides a nanofiber composite air purification filter material and its preparation method. The specific implementation method is the same as Example 1, with the difference being that the commercially available conventional polypropylene melt-blown non-woven fabric is in place of the modified melt-blown non-woven fabric A.

The conventional polypropylene melt-blown non-woven fabric in this comparison was purchased from Jiangxi Haorui Industrial Materials Co., Ltd.

### Performance Testing

The breathability, radiation resistance, and antibacterial properties of the nanofiber composite air purification filter materials in Embodiment 1-8 and Comparative Examples 1-2 were tested, and the test results are shown in Table 1.

### (1) Breathability

The breathability is determined by testing the filtration efficiency (dustproof rate) of the air purification filter material, referring to the standard GB 2626-2006.

### (2) Radiation Resistance

The radiation resistance is assessed by testing the yellowing degree. After 30 hours of exposure to sunlight using a sunshine carbon arc weather-ometer, the yellowing degree of the experimental specimens is measured with a colorimeter, which is expressed as the Yellowness Index (Y₁).

### (3) Antibacterial Properties

The antibacterial performance is assessed by the antibacterial rate. When the antibacterial rate is not less than 90%, it indicates that the sample has antibacterial effect; when the antibacterial rate is not less than 99%, it indicates that the sample has good antibacterial effect, refer to standard QB/T4371-2012.

TABLE

| | Filtration | Yellowness | Antibacterial |
|---|---|---|---|
| Group | efficiency (%) | Index (Y_{I}) | rate (%) |
| Embodiment 1 | 99.85% | 19 | 100% |
| Embodiment 2 | 99.57% | 20 | 99.4% |
| Embodiment 3 | 99.59% | 21 | 99.2% |
| Embodiment 4 | 99.67% | 22 | 99.8% |
| Embodiment 5 | 99.63% | 23 | 99.6% |
| Embodiment 6 | 95.26% | 32 | 84.5% |
| Embodiment 7 | 90.75% | 34 | 95.2% |
| Embodiment 8 | 92.45% | 36 | 96.0% |
| Comparative Example 1 | 83.65% | 47 | 75.4% |
| Comparative Example 2 | 85.53% | 52 | 77.8% |

According to the data in Table 1, the air purification filter materials in Embodiments 1-5 of the present disclosure have high breathability, radiation resistance, and antibacterial properties. Embodiment 6 changed the ratio of the main components in the modified nanoparticles, making it difficult for 1-(3-aminopropyl)imidazole and tea polyphenols to fully react with BaTiO₃ nanoparticles, resulting in a decrease in the radiation resistance and antibacterial properties of the air purification filter material, but having little effect on the breathability. Embodiments 7-8 respectively changed the proportion of polyethylene masterbatch and polypropylene masterbatch, as well as the reaction ratio between composite fibers and N-isopropylacrylamide in the modified melt-blown non-woven fabric, so that polyethylene with good breathability could not fully exert its function and the photocrosslinking reaction after absorbing radiation was insufficient or the grafting of N-isopropylacrylamide and composite fibers was incomplete, resulting in a significant decrease in the breathability and radiation resistance of the air purification filter material, but had little effect on antibacterial properties. TiO₂ powder and commercially available conventional polypropylene melt-blown non-woven fabric were selected as substitutes for modified nanoparticles A and modified melt-blown non-woven fabric A in Comparative Example 1 and Comparative Example 2, respectively. Tests showed that the prepared air purification filter material exhibited poor breathability, radiation resistance, and antibacterial properties.

The above embodiments are only intended to illustrate the technical concept and characteristics of the present disclosure, in order to enable those skilled in the art to understand the content of the present disclosure and implement it, which cannot be regarded as limitations on the scope of the present disclosure. Any equivalent changes or modifications made according to the spirit of the present disclosure should be included in the scope of the present disclosure.

1. A nanofiber composite air purification filter material, characterized by comprising:
a four-layer composite structure from top to bottom including a non-woven fabric, a nanofiber membrane layer, a modified melt-blown non-woven fabric, and a spunbond non-woven fabric,
wherein the non-woven fabric is PET needle-punched non-woven fabric;
raw materials for preparing the nanofiber membrane layer, based on weight fractions, include the following components: 10-20 parts of polylactic acid, 3-5 parts of a reinforcing agent, 2-4 parts of modified nanoparticles, and 100-150 parts of solvent;
the preparation method of the modified nanoparticles comprises the following steps:
\textcircled{1} adding TiO₂ powder to sodium hydroxide solution to obtain a first mixture, placing the first mixture in a polytetrafluoroethylene reaction vessel for sealing after ultrasonic treatment, then performing drying, washing, drying, and grinding in sequence to obtain a precursor;
\textcircled{2} taking the precursor obtained from step \textcircled{1}, adding barium nitrate and deionized water with the precursor to obtain a second mixture, placing the second mixture in a polytetrafluoroethylene reaction vessel for sealing after ultrasonic treatment, then performing heating, washing, drying, and grinding in sequence to obtain nanoparticles;
\textcircled{3} adding 1-(3-aminopropyl)imidazole, tea polyphenols, isopropanol, and deionized water in sequence to the nanoparticles obtained in step 2, then heating, stirring, drying, and grinding to obtain the modified nanoparticles;
wherein in \textcircled{3}, the mass ratio of the nanoparticles obtained in step 2, the 1-(3-aminopropyl)imidazole, and the tea polyphenols is 1:(0.3-0.5):(0.15-0.35);
the preparation method of the modified melt-blown non-woven fabric comprises the following steps:
(1) adding concentrated hydrochloric acid and deionized water to a reaction vessel, adding samarium oxide powder in batches, heating to 45-55° C., stirring, performing vacuum filtration, adding ammonia water to adjust the pH to 7.5-8.5, performing vacuum filtration, washing, filtering, and drying to obtain a first reaction product;
(2) taking the first reaction product obtained from step (1), adding methacrylic acid, heating to 75-85° C., stirring until the solution becomes clear, filtering, performing reduced-pressure distillation, cooling, performing vacuum filtration, drying to obtain a second reaction product;
(3) mixing the second reaction product obtained from in step (2) with polyethylene masterbatch, and polypropylene masterbatch, drying in a vacuum environment, and then performing extrusion and melt spinning processes to obtain composite fibers;
(4) placing ferrous sulfate, deionized water, and N-isopropylacrylamide in a reaction vessel, mixing, then adding the composite fibers from step (3), introducing inert gas for 8-15 minutes, heating at 65-75° C. for 2-4 hours, washing under ultraviolet light, drying to obtain a third mixture;
(5) performing a melt-blown process on the third mixture obtained in step (4) to obtain a modified melt-blown non-woven fabric;
wherein in step (3), the mass ratio of the second reaction product obtained from in step (2), the polyethylene masterbatch, and the polypropylene masterbatch is 1:(3-5):(7-9); in step (4), the mass ratio of the composite fibers obtained in step (3) and N-isopropylacrylamide is 1:(0.15-0.25);
a material of the spunbond non-woven fabric is PET or PP.

2. The nanofiber composite air purification filter material according to claim 1, wherein the polylactic acid in the nanofiber membrane layer is poly(L-lactic acid); and the reinforcing agent is a β-nucleating agent.

3. The nanofiber composite air purification filter material according to claim 1, wherein the solvent is polyethylene glycol or dichloromethane.

4. The nanofiber composite air purification filter material according to claim 1, wherein the preparation method of the nanofiber membrane layer comprises the following steps:
mixing the polylactic acid, the reinforcing agent, and the modified nanoparticles in a solvent, standing at 40-50° C. for 4-6 hours, stirring to obtain a blend solution, and then electrospinning to obtain a nanofiber membrane layer.

5. A method for preparing the nanofiber composite air purification filter material according to claims 1-4, comprising the following steps:
S1, stacking the non-woven fabric, the nanofiber membrane layer, the modified melt-blown non-woven fabric, and the spunbond non-woven fabric from top to bottom in sequence;
S2, bonding the four layers of materials stacked together in step S1 through ultrasonic composite, thereby forming the nanofiber composite air purification filter material.

6. The preparation method of nanofiber composite air purification filter material according to claim 5, wherein the ultrasonic composite has a power of 400-600 kW, with an ultrasonic frequency of 90-110 Hz.
